(19) United States
(12) Patent Application Publication
(10) Pub. No.: US 2005/0134108 A1
(43) Pub. Date: Jun. 23, 2005

(54) Protective cover for a vehicle wheel and shaping method therefor

(76) Inventor: Ya-Wen Chuang, Bade City (TW)

Correspondence Address: PRO-TECHTOR INTERNATIONAL, 20775 Norada Court, Saratoga, CA, 95070-3018, US

(21) Appl. No.: 10/740,247

(22) Filed: Dec. 17, 2003

(51) Int. Cl. B60B 7/00

(52) U.S. Cl. 301/37.101; 301/37.43

(57) ABSTRACT

A metal protective cover includes an annular insertion section and an enveloping section. The protective cover further includes a rearward extending portion that extends rearward from the enveloping section. The rearward extending portion includes an annular extension that is shaped to form a fold. The rearward extending portion of the protective cover shaped by the method will not restore its shape before shaping. The fold of the protective cover securely engages a stepped portion of a vehicle wheel. Thus, the rearward extending portion of the protective cover can be reliably engaged with the vehicle wheel. A durable and reliable protective cover is thus provided.

### BACKGROUND OF THE INVENTION

1. Field of the Invention

The present invention relates to a protective cover for a vehicle wheel. In particular, the present invention relates to a metal protective cover having improved engaging reliability with a vehicle wheel while providing improved safety. The present invention also relates to a method for shaping the protective cover.

2. Description of the Related Art

Vehicle wheels generally include steep plate type, steel spoke type, and aluminum alloy type. Aluminum alloy wheels are widely used, as they are light and have a greater cross-section and greater radius while providing excellent heat conductivity as well as a shining appearance. A typical aluminum alloy wheel is formed by gravity casting and then subject to several procedures of grinding and polishing to obtain a shining appearance. However, after a period of time, the shine of the appearance of the aluminum alloy wheel fades, particularly at an inner wall of a front portion of the rim and at a front circumferential surface of a flange on the front end of the rim, and the appearance of the aluminum alloy wheel is apt to be damaged. As a result, the protective cover no longer provides an aesthetically pleasing appearance.

FIG. 1 is a perspective view of a vehicle wheel 10 and a conventional protective cover 18. FIG. 2 is a partial sectional view of the vehicle wheel 10 and the conventional protective cover 18. The wheel 10 is made of aluminum alloy by gravity casting and includes a central hub 11, a plurality of spokes 12 extending radially outward from the central hub 11, and a rim 13 having a front portion 15, a rear portion 16, and an intermediate portion 14. A front annular flange 17 projects outward from the front portion 15 of the rim 13 and includes a front circumferential surface 171 and an outer circumferential edge 172. The protective cover 18 is made of stainless steel and includes, from inside to outside in sequence, an annular insertion section 181 and an enveloping section 182 for enveloping the front circumferential surface 171 of the front annular flange 17. The protective cover 18 further includes a rearward extending portion 183 that extends rearward from an annular distal portion of the enveloping section 18 and envelops the outer circumferential edge 172 of the front annular flange 17.

The protective cover 18 assures required shining effect and improved surface strength for the wheel 10. Nevertheless, the rearward extending portion 183 of the protective cover 18 is formed by means of direct rolling and thus has insufficient strength. Namely, the rolled material may restore its shape under the action of its inherent elasticity. Thus, the protective cover 18 is neither reliable nor durable.

### SUMMARY OF THE INVENTION

An object of the present invention is to provide a method for shaping a rearward extending portion of a protective cover so that the rearward extending portion of the protective cover that will not restore its shape before shaping. Thus, the rearward extending portion of the protective cover can be reliably engaged with a wheel and is thus durable.

Another object of the present invention is to provide a method for shaping a rearward extending portion of a protective cover, wherein a sharp distal portion of the rearward extending portion is hidden and thus provides improved safety during use.

A method for shaping a rearward extending portion of a protective cover for a wheel of a vehicle in accordance with the present invention includes:
providing a metal protective cover including an annular insertion section and an enveloping section, the protective cover further including a rearward extending portion that extends rearward from the enveloping section, the rearward extending portion including an annular extension projecting radially outward;
forming an inwardly facing stepped portion on an outer circumferential edge of a front annular flange of a rim of a wheel of a vehicle;
placing the metal protective cover on a turntable and placing the wheel on top of the metal protective cover;
lowering a pressing member above the turntable to securely press against the wheel and the protective cover, with the annular insertion section enveloping an inner face of a front portion of a rim of a wheel, and with the enveloping section enveloping a front circumferential surface of a front annular flange that projects outward from the front portion of the rim of the wheel, and with the annular extension being located outside the turntable;
turning the turntable;
moving a first roll toward a side of the rotating turntable until the first roll presses against the annular extension, thereby forming a semi-fold;
disengaging the first roll from the turntable; and
moving a second roll toward another side of the rotating turntable until the second roll presses against the semi-fold, thereby forming a fold that presses against and is thus securely retained in the stepped portion of the wheel.

A protective cover for a wheel of a vehicle in accordance with the present invention includes an annular insertion section and an enveloping section, with the annular insertion section enveloping an inner wall of a front portion of a rim of a wheel, and with the enveloping section enveloping a front circumferential surface of a front annular flange of the wheel. The protective cover further includes a rearward extending portion that envelops an outer circumferential edge of the front annular flange of the rim of the wheel. The rearward extending portion includes an extension that is processed and thus shaped to form a fold that presses against a stepped portion of the outer circumferential edge of the front annular flange of the rim of the wheel.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a vehicle wheel and a conventional protective cover.

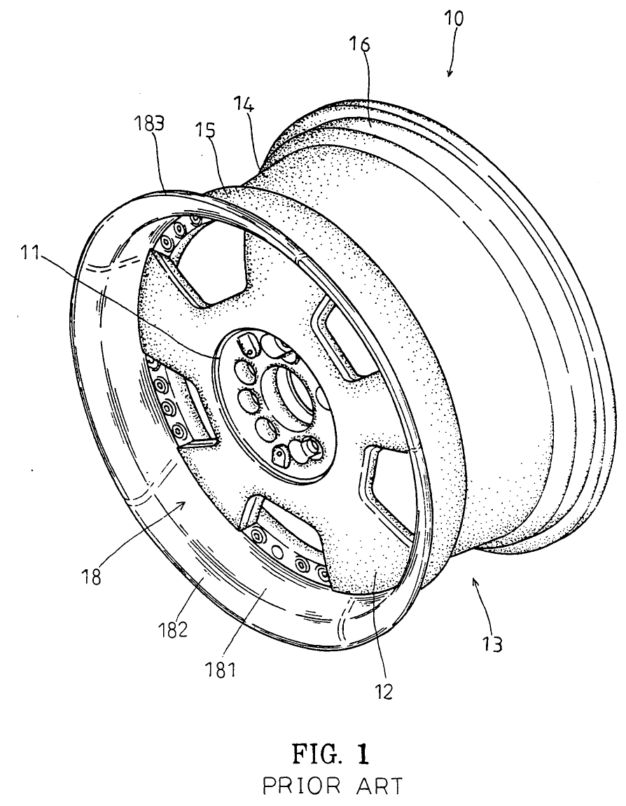

FIG. 2 is a partial sectional view of the vehicle wheel and the conventional protective cover in FIG. 1.

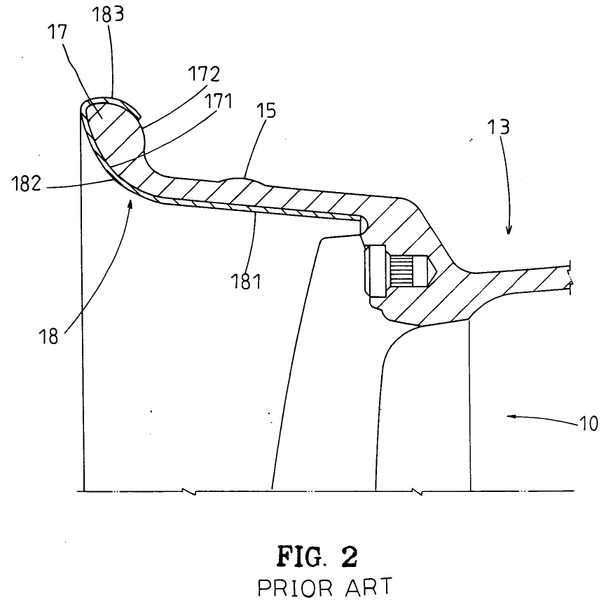

FIG. 3 is a partial sectional view of a vehicle wheel and a protective cover in accordance with the present invention.

FIG. 4 is a perspective view of the protective cover in accordance with the present invention.

FIG. 5 is a perspective view of an apparatus for shaping the protective cover in accordance with the present invention.

FIG. 6 is a side view of the apparatus and the protective cover in FIG. 5.

FIG. 7 is a side view similar to FIG. 6, wherein a vehicle wheel is securely engaged with the protective cover and wherein the protective cover is in a position ready for shaping.

FIG. 8 is an enlarged view, partly sectioned, of the apparatus, the vehicle wheel, and the protective cover in FIG. 7.

FIG. 9 is a further enlarged sectional view illustrating a step for shaping a rearward extending portion of the protective cover.

FIG. 10 is a view similar to FIG. 9, illustrating result of the step for shaping.

FIG. 11 is a view similar to FIG. 10, illustrating another step of shaping the rearward extending portion of the protective cover.

FIG. 12 is a view similar to FIG. 11, illustrating the protective cover after shaping.

### DETAILED DESCRIPTION OF THE PREFERRED EMBODIMENT

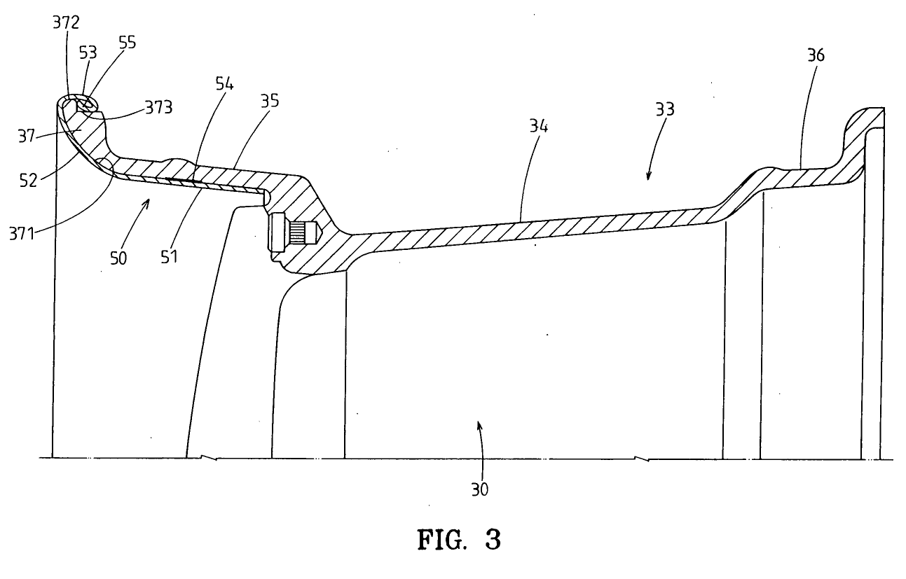

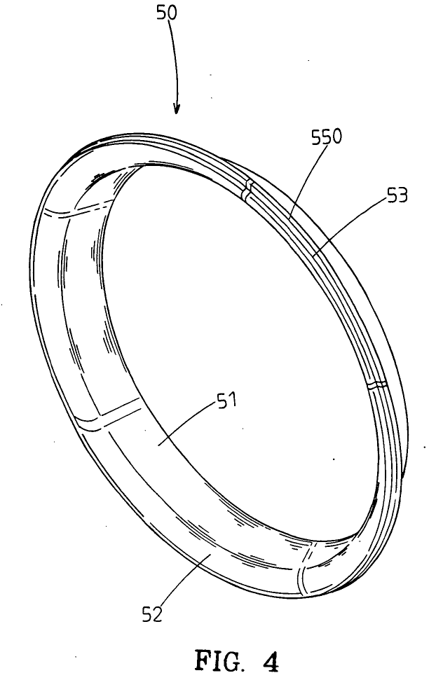

Referring to FIGS. 3 and 4, a wheel 30 includes central hub (not labeled), a plurality of spokes (not labeled) extending radially outward from the central hub, and a rim 33 having a front portion 35, a rear portion 36, and an intermediate portion 34. The rim 33 further includes a front annular flange 37 projecting outward from the front portion 15. The front annular flange 37 includes a front circumferential surface 371 and an outer circumferential edge 372. The outer circumferential edge 372 includes a stepped portion 373 that faces inward.

A protective cover 50 made of metal (preferably stainless steel) is attached to the wheel 30 and includes, from inside to outside in sequence, an annular insertion section 51 and an enveloping section 52, with the annular insertion section 51 enveloping an inner face of the front portion 35 of the rim 33, and with the enveloping section 52 enveloping the front circumferential surface 371 of the front annular flange 37. Further, the protective cover 50 includes a rearward extending portion 53 that a rearward extending portion that envelops an outer circumferential edge 372 of the front annular flange 37. The rearward extending portion 53 includes an extension 550 that is processed and thus shaped to form a fold 55 that presses against the stepped portion 373. Silicon rubber 54 is applied to an outer face of the annular insertion section 51 for bonding with the inner face of the front portion 35 of the rim 33.

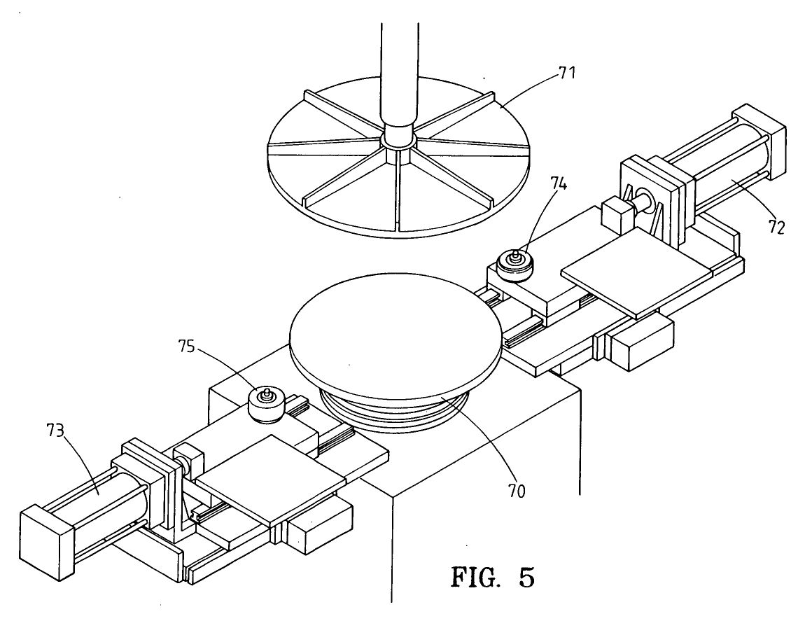

FIG. 5 illustrates an apparatus for shaping the rearward extending portion 53 of the protective cover 50 in accordance with the present invention. The protective cover 50 is pre-pressed to provide an annular extension 550 that is subsequently processed by the apparatus to form a fold 55 that presses against the stepped portion 373 of the rim 33.

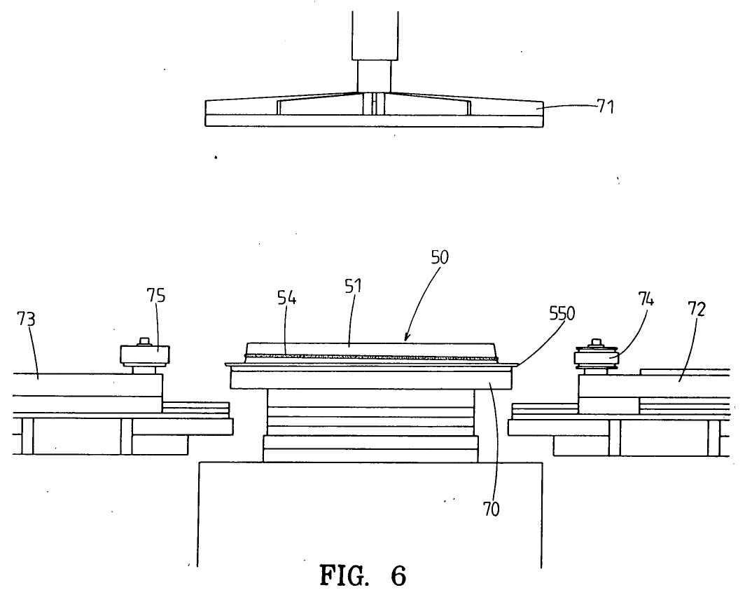

As illustrated in FIGS. 5 and 6, the apparatus includes a turntable 70, a vertically movable and rotatable pressing member 71 above the turntable 70, and two roll mechanisms 72 and 73 respectively located on two sides of the turntable 70. Each roll mechanism 72, 73 includes a freely rotatable roll 74, 75.

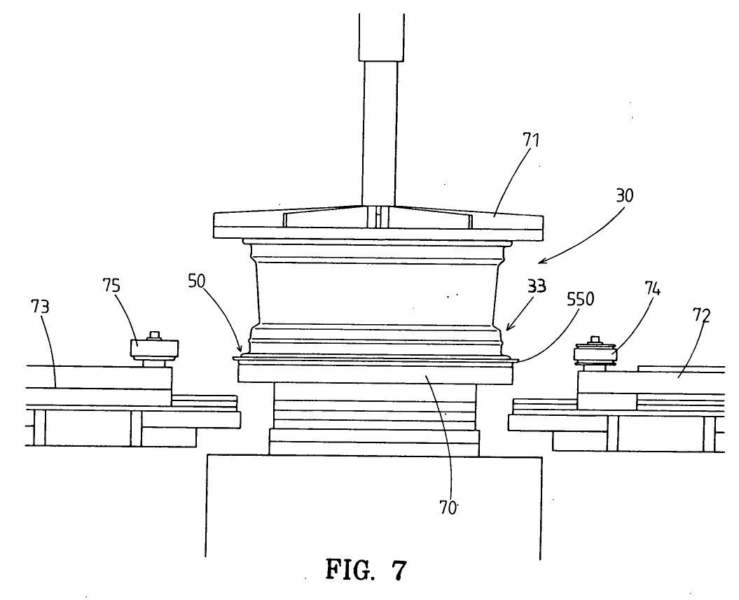

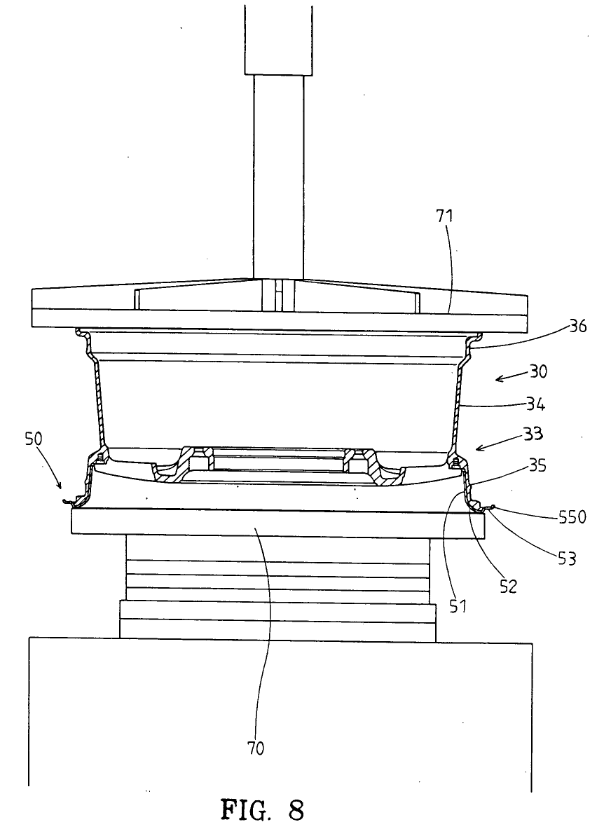

The protective cover 50 with an annular extension 550 is placed on the turntable 70 of the apparatus, as shown in FIG. 6. Then, the wheel 30 is placed on top of the protective cover 50, and the pressing member 71 is lowered to press against the wheel 30. The wheel 30 is thus engaged with the protective cover 50, as shown in FIG. 7. Before engagement between the wheel 30 and the protective cover 50, silicon rubber 54 is applied to an outer face of the annular insertion section 51 for bonding with the inner face of the front portion 35 of the rim 33. As illustrated in FIG. 8, the annular extension 550 of the protective cover 50 is located outside the turntable 70 for subsequent shaping.

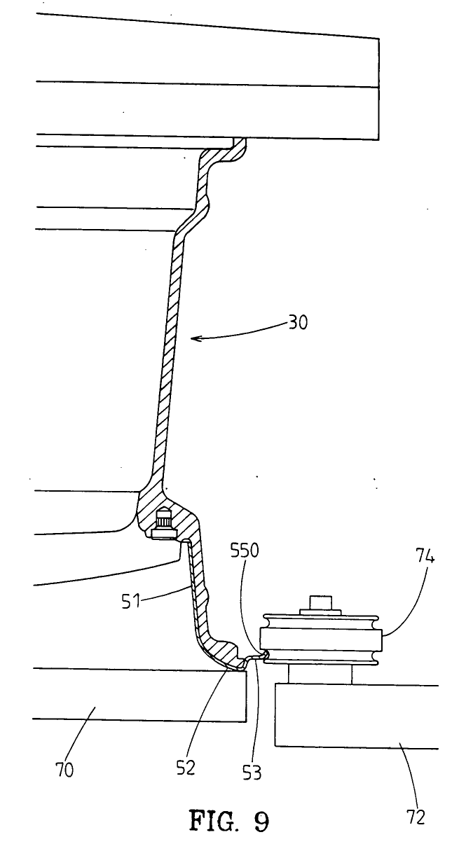

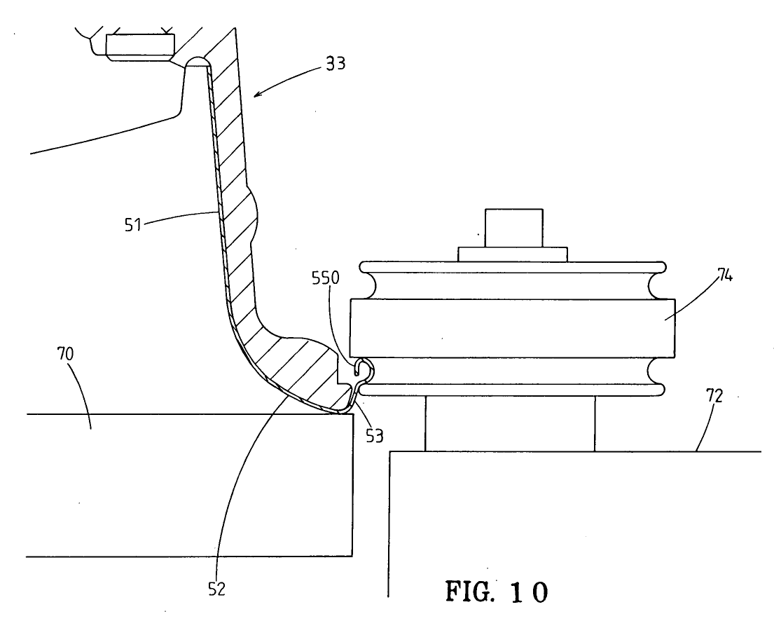

The turntable 70 is turned, and the roll mechanism 72 is actuated to move the roll 74 toward the turntable 70 until the roll 74 presses against the annular extension 550 of the protective cover 50, as shown in FIG. 9. An annular semi-fold formed from the annular extension 550 of the protective cover 50 is thus shaped under the action of the pressing force while the turntable 70 and the freely rotatable roll 74 are turning, as shown in FIG. 10.

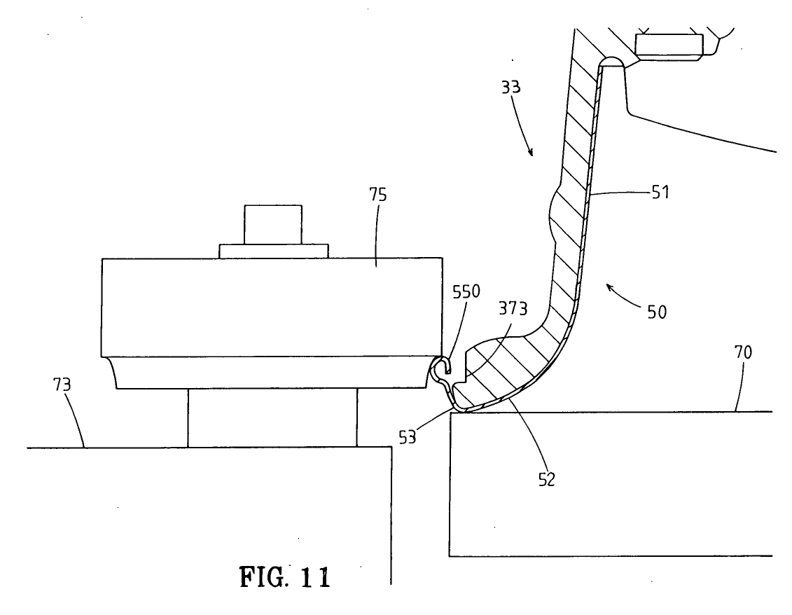

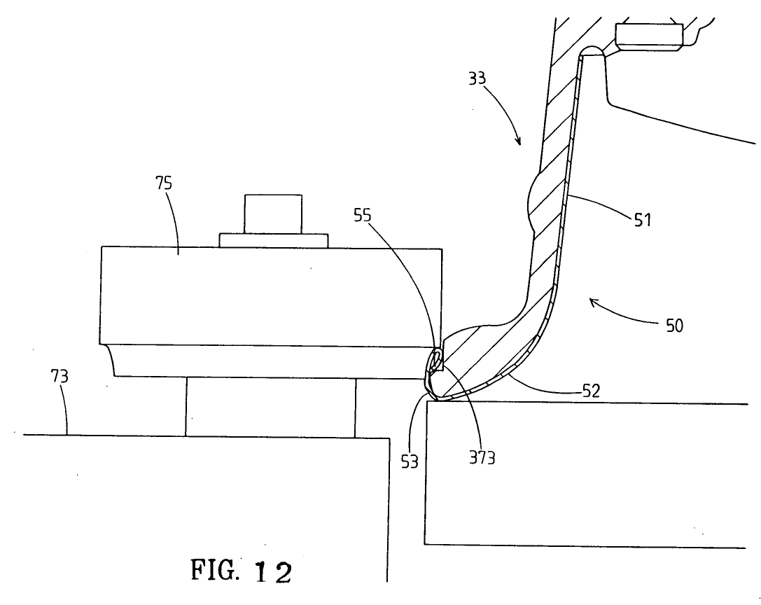

Next, the roll 74 is moved away from the turntable 70, and the roll mechanism 73 is actuated to move the roll 75 toward the turntable 70 until the roll 75 presses against the annular extension 550 of the protective cover 50, as shown in FIG. 11. An annular fold 55 on the protective cover 50 is thus shaped under the action of the pressing force while the turntable 70 and the freely rotatable roll 75 are turning, as shown in FIG. 12. It is noted that the fold 55 presses against and is thus retained in the stepped portion 373 of the rim 33.

The rearward extending portion 53 of the protective cover 50 shaped by the method in accordance with the present invention will not restore its shape before shaping. The fold 55 of the protective cover 50 securely engages the stepped portion 373 of the rim 33. Thus, the rearward extending portion 53 of the protective cover can be reliably engaged with a wheel. A durable and reliable protective cover 50 is thus provided. Further, a sharp distal portion of the fold 55 of the rearward extending portion 53 of the protective cover 50 is hidden in the stepped portion 373 of the rim 33. Improved safety during use is provided.

Although the invention has been explained in relation to its preferred embodiment, it is to be understood that many other possible modifications and variations can be made without departing from the scope of the invention as hereinafter claimed.

1. A method for shaping a rearward extending portion of a protective cover for a wheel of a vehicle, the method comprising:
providing a metal protective cover including an annular insertion section and an enveloping section, the protective cover further including a rearward extending portion that extends rearward from the enveloping section, the rearward extending portion including an annular extension projecting radially outward;
forming an inwardly facing stepped portion on an outer circumferential edge of a front annular flange of a rim of a wheel of a vehicle;
placing the metal protective cover on a turntable and placing the wheel on top of the metal protective cover;
lowering a pressing member above the turntable to securely press against the wheel and the protective cover, with the annular insertion section enveloping an inner face of a front portion of a rim of a wheel, and with the enveloping section enveloping a front circumferential surface of a front annular flange that projects outward from the front portion of the rim of the wheel, and with the annular extension being located outside the turntable;
turning the turntable;
moving a first roll toward a side of the rotating turntable until the first roll presses against the annular extension, thereby forming a semi-fold;
disengaging the first roll from the turntable; and
moving a second roll toward another side of the rotating turntable until the second roll presses against the semi-fold, thereby forming a fold that presses against and is thus securely retained in the stepped portion of the wheel.

2. The method as claimed in claim 1, wherein the annular insertion section of the protective cover and the inner face of the front portion of the rim of the wheel are bonded by silicon rubber.

3. The method as claimed in claim 1, wherein the metal protective cover is made of stainless steel.

4. A protective cover for a wheel of a vehicle, the protective cover including an annular insertion section and an enveloping section, with the annular insertion section enveloping an inner wall of a front portion of a rim of a wheel, and with the enveloping section enveloping a front circumferential surface of a front annular flange of the wheel, the protective cover further including a rearward extending portion that envelops an outer circumferential edge of the front annular flange of the rim of the wheel, the rearward extending portion including an extension that is processed and thus shaped to form a fold that presses against a stepped portion of the outer circumferential edge of the front annular flange of the rim of the wheel.

5. The protective cover as claimed in claim 4, wherein the annular insertion section of the protective cover and the inner face of the front portion of the rim of the wheel are bonded by silicon rubber.
